(19) United States
(12) Patent Application Publication
(10) Pub. No.: US 2003/0112368 A1
(43) Pub. Date: Jun. 19, 2003

(54) Displaying device capable of displaying additional signal on blanking area of screen and displaying method thereof

(75) Inventor: Ji-Byoung Oh, Hwasung-gun (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/242,724

(22) Filed: Sep. 13, 2002

(30) Foreign Application Priority Data
Dec. 19, 2001 (KR) 2001-81003

(51) Int. Cl. H04N 11/20

(52) U.S. Cl. 348/445

(57) ABSTRACT

Disclosed is an image displaying device having a function of aspect ratio converting. The device has a CRT to display a video signal, an OSD/OSG generation unit to generate an additional signal, and a controller to control a display unit in order to display the additional signal in blanking areas which do not display the video signal. Moreover, the device has a luminance detection unit to detect a luminance level of the video signal displayed on the display unit, and the controller controls a signal generation unit to generate the additional signal corresponding to the luminance level detected from the luminance detection unit. Therefore, as the aspect ratio is changed, the additional signal is output to the blanking area when there is no blanking area in the CRT. Accordingly, the CRT is not different for the displaying area and the blanking area as the color of the screen is not changed.

### BACKGROUND OF THE INVENTION

1. Field of the Invention

The present invention relates to an image processor, and more particularly, to a TV capable of protecting the screen of a CRT of an image displaying device having a function of aspect ratio converting. The present application is based on Korean Patent Application No. 2001-81003, which is incorporated herein by reference.

2. Description of the Prior Art

As shown in FIG. 1 for general broadcasting, when the screen having an aspect ratio of 4:3 is changed to a wide screen with an aspect ratio of 16:9, a left-most part and a right-most part of the screen where a video signal is displayed in the 4:3 aspect ratio are blanking areas where the video signal is not displayed in the 16:9 aspect ratio.

Moreover, when the usage rates of the displaying area and the blanking areas on the screen, in accordance with the aspect ratio conversion, are compared, the usage rate of the blanking areas is relatively less. In other words, as the image processing device of an aspect ratio of 16:9 is used longer after the screen conversion, the video signal is displayed only on the displaying area of a display device. Therefore, the light is projected to the displaying area and the blanking area in different amounts. Thus, the screen of the display device is worse in the displaying area compared with the blanking areas. Accordingly, the blanking areas of the screen of the display device are burnt, which is the color to which the screen is changed.

Due to such change of the color of the screen, the resolution of the video signal processed on the usual screen decreases.

The same problem is generated in a TV having an aspect ratio of 16:9 that can be converted to the aspect ratio of 4:3.

### SUMMARY OF THE INVENTION

The present invention has been made to overcome the above-mentioned problem of the prior art. Accordingly, it is the object of the present invention to provide an image displaying device which can improve the state of the CRT and reduce eyestrain of a user by displaying a predetermined additional signal in blanking areas generated when the aspect ratio is converted.

The above object of the present invention is realized by providing an image displaying device comprising: a display unit to display a received video signal; a detection unit to detect a luminance level of the video signal displayed on the display unit; a signal generation unit to generate an additional signal having a brightness corresponding to the detected luminance level; and a controller to control the display unit in order to display the additional signal in a blanking area which does not display the video signal on a screen of the display unit.

Moreover, the controller controls a generation timing of the additional signal by synchronizing a projection timing of a projection signal projected to the display unit with the generation timing of the additional signal.

Preferably, the signal generation unit is either an on screen display (OSD) generation unit or an on screen graphics (OSG) generation unit.

In the meantime, an image displaying method in an aspect ratio conversion mode according to the present invention comprises the steps of: detecting a luminance level of a video signal displayed on a display unit; generating an additional signal having a brightness corresponding to the detected luminance level; and displaying the additional signal in an area which does not display the video signal in the display unit.

In addition, in the detecting step, the luminance level is detected in real time, and the additional signal is generated by either the OSD generation unit or the OSG generation unit.

Furthermore, in the displaying step, a generation timing of the additional signal is controlled by synchronizing with a synchronizing signal to synchronize a projection timing of a projection signal projected to the display unit.

### BRIEF DESCRIPTION OF THE DRAWINGS

The above-mentioned object and the feature of the present invention will be more apparent by describing the preferred embodiment of the present invention by referring to the appended drawings, in which:

FIG. 1 is a view showing the state that a composite video signal of an image displaying device is displayed on a screen;

FIG. 2 is a block diagram showing the structure of an image displaying device according to the preferred embodiment of the present invention;

FIG. 3 is a view showing a vertical area displayed on a screen of the image displaying device in accordance with FIG. 2; and

FIG. 4 is a flow chart showing a screen displaying method according to FIG. 2.

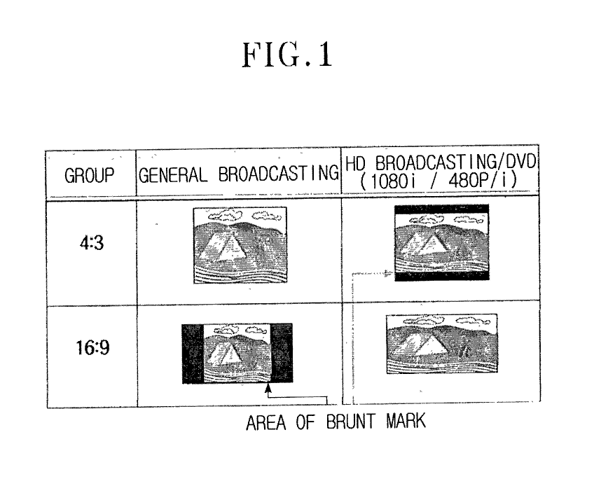

### DESCRIPTION OF THE PREFERRED EMBODIMENT

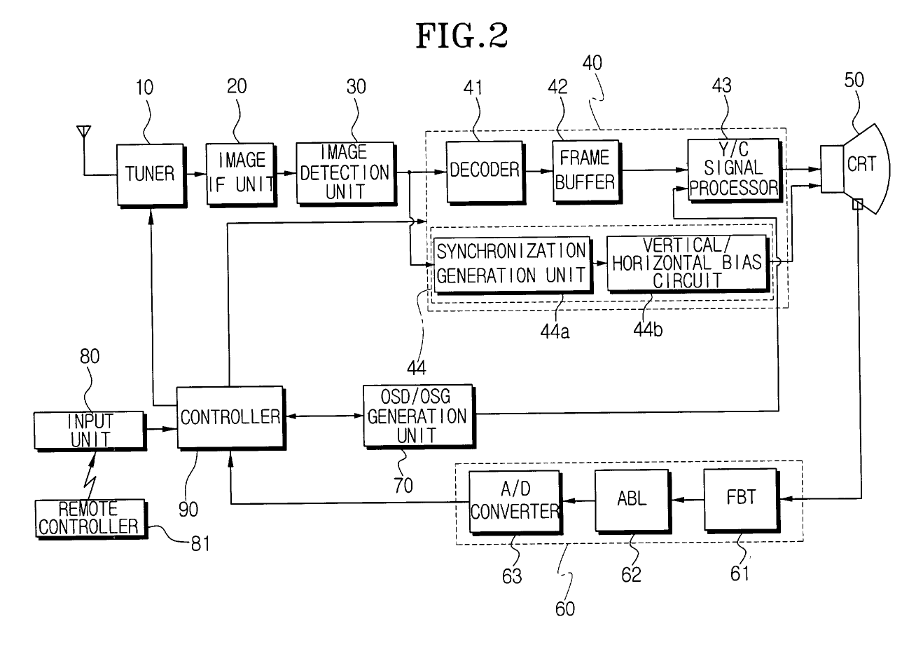

Hereinbelow, the present invention will be described in greater detail by referring to FIG. 2. In the preferred embodiment of the present invention, a TV that is converted from a screen with an aspect ratio of 4:3 to a screen with an aspect ratio of 16:9 will be described.

The TV has a tuner 10, an image IF unit 20, an image detection unit 30, an image processing unit 40, a display device (hereinafter called a CRT) 50, a luminance detection unit 60, an OSD/OSG generation unit 70, an input unit 80, and a controller 90.

The controller 90 controls the tuner 10 to select a certain channel in response to a channel selection signal input through the input unit 80. Generally, the input unit 80 is a manipulation panel (not shown) installed in a main body of the TV. Moreover, a user can input a channel selection command through a remote controller 81.

The tuner 10 selects a broadcasting signal of a selected channel in response to the channel selection command input by the user.

The image IF unit 20 separates a video intermediate frequency signal and an audio intermediate frequency signal from an intermediate frequency signal of the broadcasting signal selected by the tuner 10, and amplifies the video intermediate frequency signal and the audio intermediate frequency signal.

The processing of a signal in regard to the audio intermediate frequency signal will be omitted here.

The image detection unit 40 detects a composite video signal that is a modulated element of the video intermediate frequency signal from the video intermediate frequency signal.

The image processing unit 40 has a decoder 41, a frame buffer 42, a Y/C signal processor 43, and a deflecting unit 44.

The decoder 41 converts a detected video signal. In other words, the decoder 41 converts the composite video signal (CVBS: composite video blanking synchronization) into a digital signal. The composite video signal that has been converted into the digital signal is stored in the frame buffer 42 as a unit of a frame.

The Y/C signal processor 43 separates the received composite video signal into a luminance signal (Y signal) for showing the brightness of the screen, and a color signal (C signal) for showing the characteristic of the color, and processes the signals. The luminance signal and the color signal processed in the Y/C signal processor 43 are converted to analog signals through a digital analog converter (not shown), and projected to the CRT 50 in sync with a synchronizing signal (will be described later).

The deflecting unit 44 has a synchronization generation unit 44a and a vertical/horizontal deflecting circuit 44b.

The synchronization generation unit 44a separates the synchronizing signal from the detected composite video signal, and the vertical/horizontal deflecting circuit 44b synchronizes with the separated synchronizing signal.

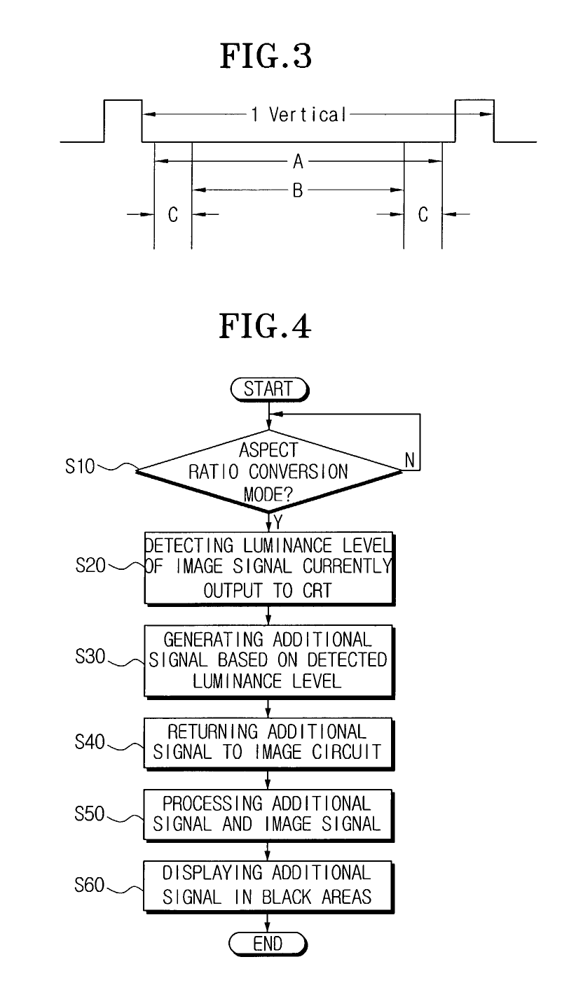

FIG. 3 shows a vertical area (1 vertical) deflected to the CRT 50 by the vertical deflecting circuit. As shown in FIG. 3, the video signal is displayed in a signal area of the vertical area in the usual screen mode (aspect ratio 4:3). On the other hand, when the screen mode is converted to the wide screen mode (aspect ratio 16:9) by an aspect ratio conversion mode, the composite video signal is displayed in the displaying area, and an additional signal is displayed in the blanking areas. The additional signal will be described later.

The luminance detection unit 60 detects a luminance level of the composite video signal currently output to the CRT 50 when the selection command with respect to the aspect ratio conversion mode is input by the user through the input unit 80.

The luminance detection unit 60 has an FBT (flyback transformer) 61, an ABL (automatic beam limiter) 62, and an ADC (analog digital converter) 63.

The FBT 61 is used to detect the amount of electric current of the composite video signal currently output to the displaying area of the CRT 50.

The ABL 62 outputs a voltage value corresponding to the amount of detected electric current from the FBT 61, and the output voltage value is converted to a digital value by the ADC 63. After that, the luminance level of the composite video signal output to the CRT 50 is detected.

The controller 90 drives the OSD (on screen display)/OSG (on screen graphics) generation unit 70 in response to the luminance level detected by the luminance detection unit 60. In other words, the OSD/OSG generation unit 70 is controlled to generate additional signals, such as the luminance level of the composite video signal currently output to the CRT 50.

Moreover, the controller 90 controls the additional signals generated by the OSD/OSG generation unit 70 to be displayed in the blanking areas when the aspect ratio conversion mode is operated.

In other words, the additional signals generated from the OSD/OSG generation unit 70 are returned to the Y/C signal processor 43 of the image processing unit 40.

Therefore, the currently transmitted composite video signal and the additional signals generated from the OSD/OSG generation unit 70 are processed at the Y/C signal processor 43. In other words, the luminance signal (Y signal) that is a signal for showing the brightness of the screen and the color signal (C signal) that is a signal for showing the characteristic of the color are processed and output to the CRT 50. Accordingly, a video signal having a same luminance level is output to the entire screen of the CRT 50.

The controller 90 drives the detection unit 60 in real time and performs the above compensation process for the luminance level when the aspect ratio conversion mode is selected through the input unit 80.

According to the preferred embodiment of the present invention, when the screen is converted from the usual screen (4:3) to the wide screen (16:9) as shown in FIG. 3, the vertical area (1 vertical) is shown as the displaying area B for displaying the video signal and a signal area A having an OSD/OSG area placed at the upper part and the lower part of the displaying area in order to be displayed as the additional signals generated by the OSD/OSG generation unit 70.

On the other hand, when the TV having the screen of 16:9 is converted to the screen mode of 4:3, a displaying area for displaying the video signal with respect to a horizontal area (1 horizontal), and a signal area having an OSD/OSG area for displaying the additional signals appear at both sides of the displaying area.

Therefore, as the luminance level of the blanking areas generated in the CRT 50 and the displaying area are the same in the aspect ratio conversion mode, the watching efficiency is increased and the display device is prevented from being deteriorated.

Hereinbelow, the screen displaying method according to the preferred embodiment of the present invention will be described by referring to FIG. 4.

When the user selects the aspect ratio conversion mode by manipulating the remote controller 81 of the input unit 80 (S 10), the luminance detection unit 60 detects the luminance level of the composite video signal currently output to the CRT 50 (S 20).

The OSD/OSG generation unit 70 generates additional signals having the same luminance level in response to the detected luminance level (S 30).

The generated additional signals are returned to the Y/C signal processor 43 (S 40), and processed with the composite video signal of a currently transmitted broadcasting signal (S 50).

Accordingly, additional signals having the same luminance level as the currently broadcasted composite video signal are output (S 60).

In the above case, only the luminance level can be the same, or an imaginary signal having the same luminance level and a similar color difference signal with respect to the color difference signal of the currently broadcasted video signal can be displayed. In other words, the video signal having the same luminance level is displayed in the displaying area that is the signal area of the CRT 50 and the blanking areas.

The above screen displaying method can protect the state of the screen of the CRT 50 as the additional signal, which has the same luminance level as the composite video signal output to the screen of the CRT 50 after being converted in real time, is output to the blanking areas of the aspect ratio conversion mode.

The case of the displaying unit being a CRT has been described for the preferred embodiment of the present invention, but the displaying unit can be an LCD or plasma display panel (PDP).

In addition, as an imaginary signal having the same luminance level and a similar color difference signal with the currently broadcasted video signal, the screen of the displaying unit can be protected from being damaged, the user does not suffer eyestrain and the watching efficiency will increase.

According to the present invention, the state of the screen is protected as the luminance level of the currently broadcasted video signal is detected for real time and the additional signal having the same level with the detected luminance level is output to the blanking areas when the aspect ratio conversion mode is operated.

In other words, the problem that the color of the screen of the display device is changed as video signals having different luminance levels are displayed in the blanking areas of the image display unit and the displaying unit for displaying the video signal, which occurs when the aspect ratio is conventionally converted, is prevented in the present invention.

Although the preferred embodiment of the present invention has been described, it will be understood by those skilled in the art that the present invention should not be limited to the described preferred embodiment, but various changes and modifications can be made within the spirit and the scope of the present invention. Accordingly, the scope of the present invention is not limited within the described range but by the following claims.

What is claimed is:

1. An image displaying device comprising:
a display unit to display a received video signal;
a detection unit to detect a luminance level of the video signal displayed on the display unit;
a signal generation unit to generate an additional signal having a brightness corresponding to the detected luminance level; and
a controller to control the display unit in order to display the additional signal in a blanking area which does not display the video signal on a screen of the display unit.

2. The image displaying device of claim 1, wherein the controller controls a generation timing of the additional signal by synchronizing a projection timing of a projection signal projected to the display unit with the generation timing of the additional signal.

3. The image displaying device of claim 1, wherein the signal generation unit is either an on screen display (OSD) generation unit or an on screen graphics (OSG) generation unit.

4. An image displaying method comprising the steps of:
detecting a luminance level of a video signal displayed on a display unit;
generating an additional signal having a brightness corresponding to the detected luminance level; and
displaying the additional signal in an area which does not display the video signal in the display unit.

5. The image displaying method of claim 4, wherein, in the detecting step, the luminance level is detected in real time.

6. The image displaying method of claim 4, wherein, in the displaying step, a generation timing of the additional signal is controlled by synchronizing with a synchronizing signal to synchronize a projection timing of a projection signal projected to the display unit.

7. The image displaying method of claim 4, wherein the displaying step displays the additional signal through at least one of an OSD screen and an OSG screen.
